(19) United States
(12) Patent Application Publication
(10) Pub. No.: US 2015/0328664 A1
(43) Pub. Date: Nov. 19, 2015

(54) VIBRATOR

(71) Applicant: SAMSUNG ELECTRO-MECHANICS CO., LTD., Suwon-si (KR)

(72) Inventor: Jae Kyung KIM, Suwon-si (KR)

(73) Assignee: SAMSUNG ELECTRO-MECHANICS CO., LTD., Suwon-si (KR)

(21) Appl. No.: 14/601,238

(22) Filed: Jan. 21, 2015

(30) Foreign Application Priority Data
May 14, 2014 (KR) 10-2014-0057876

(51) Int. Cl. B06B 1/06

(52) U.S. Cl. CPC B06B 1/0644

(57) ABSTRACT

A vibrator is configured by fixing a vibrating member provided to be bent multiple times to be vibratable to a housing having an internal space and coupling a mass body and a piezoelectric element to the vibrating member. A natural frequency of the vibrator may be maintained and the vibrator may be miniaturized.

### CROSS-REFERENCE TO RELATED APPLICATION

This application claims the priority and benefit of Korean Patent Application No. 10-2014-0057876 filed on May 14, 2014, with the Korean Intellectual Property Office, the disclosure of which is incorporated herein by reference.

### BACKGROUND

The present disclosure relates to a vibrator.

A vibrator, a device mounted in a portable electronic device such as a mobile phone, or the like, has been variously used.

Meanwhile, in accordance with a trend for the addition of increased functionality to portable electronic devices, various electronic parts are mounted in the portable electronic devices.

Therefore, the miniaturization of vibrators mounted in portable electronic devices is demanded.

In the case in which the size of the vibrator is decreased, however, there may be a problem in that a resonance frequency may be changed.

Therefore, research into vibrators capable of maintaining a resonance frequency while decreasing the size of the vibrator has been urgently demanded.

### SUMMARY

An aspect of the present disclosure may provide a vibrator capable of having a decreased size while maintaining a resonance frequency.

According to an aspect of the present disclosure, a vibrator may be configured by fixing a vibrating member provided to be bent multiple times to be vibratable, to a housing having an internal space, and coupling amass body and a piezoelectric element to the vibrating member. Therefore, a size of the vibrator may be reduced while maintaining a resonance frequency thereof.

In the vibrator according to an exemplary embodiment of the present disclosure, the vibrating member may include a first member fixed to the housing, a second member extended from the first member and bent multiple times, and a third member extended from the second member, whereby a natural frequency of the vibrator may be maintained while reducing a size of the vibrator.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an exploded perspective view of a vibrator according to an exemplary embodiment of the present disclosure;

FIG. 2 is a cross-sectional view of the vibrator in a coupled state according to an exemplary embodiment of the present disclosure;

FIG. 3A is a perspective view of a vibrating member according to an exemplary embodiment of the present disclosure and FIG. 3B is a bottom perspective view of the vibrating member according to an exemplary embodiment of the present disclosure;

FIG. 4 is a cross-sectional view taken along line A-A′ of FIG. 3A;

FIG. 5 is a perspective view of a mass body according to an exemplary embodiment of the present disclosure;

FIG. 6 is a plan view illustrating a form in which the mass body and the vibrating member according to an exemplary embodiment of the present disclosure are coupled.

FIG. 7 is a cross-sectional view of a vibrator in a coupled state according to another exemplary embodiment of the present disclosure;

FIG. 8 is a cross-sectional view of a vibrator in a coupled state according to another exemplary embodiment of the present disclosure;

FIG. 9 is a cross-sectional view of a vibrator in a coupled state according to another exemplary embodiment of the present disclosure; and

FIG. 10 is a cross-sectional view of a vibrator in a coupled state according to another exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

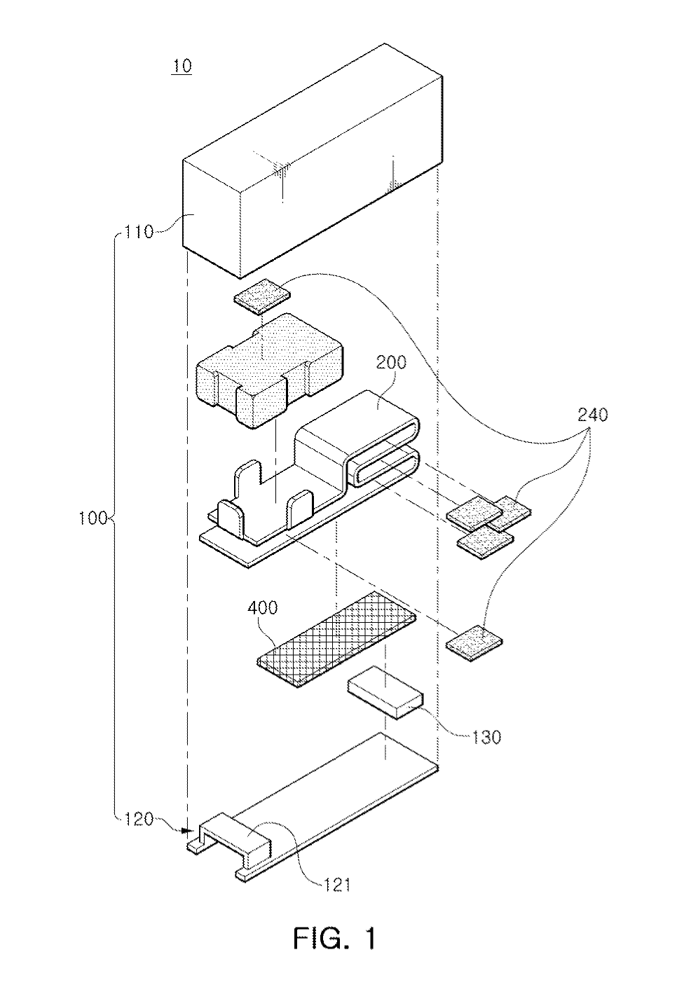

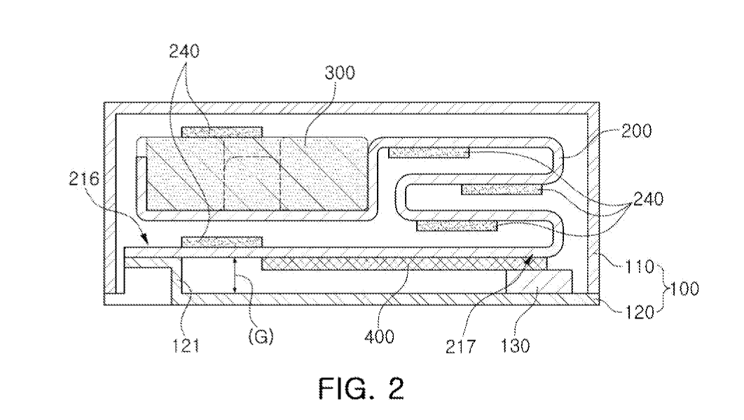

FIG. 1 is an exploded perspective view of a vibrator according to an exemplary embodiment of the present disclosure and FIG. 2 is a cross-sectional view of the vibrator 10 in a coupled state according to an exemplary embodiment of the present disclosure.

Referring to FIGS. 1 and 2, a vibrator 10 according to an exemplary embodiment of the present disclosure may include a housing 100, a vibrating member 200, a mass body 300, and a piezoelectric element 400.

The housing 100, which is a member forming an appearance of the vibrator 10, may include an upper case 110 having one open side and a lower case 120 coupled to the one open side to form an internal space thereof.

In this case, the upper case 110 and the lower case 120 may be coupled to each other by various methods such as a welding method, a bonding method using an adhesive, a hook coupling method, and the like.

Meanwhile, the vibrating member 200, the mass body 300, and the piezoelectric element 400 to be described below are provided in the internal space.

In addition, the lower case 120 may be provided with a supporting member 121 protruding into the internal space.

Here, the supporting member 121 may be manufactured by bending one end of the lower case 120 or may be manufactured simultaneously at the time of manufacturing the lower case 120 to be formed integrally.

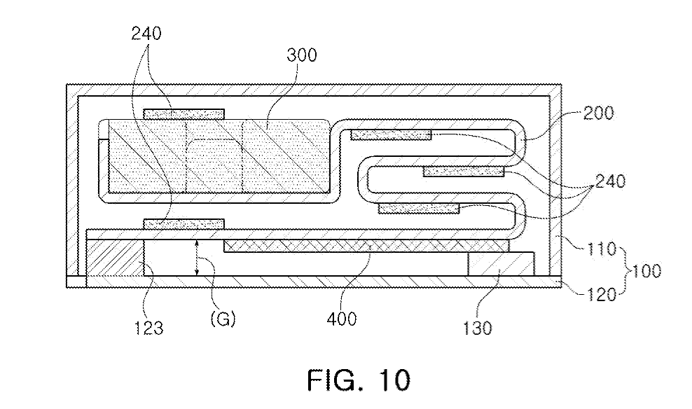

The supporting member 121 is not limited to being formed by bending the housing 100, in detail, the lower case 120, and may also be provided by allowing a separate support member 123 to be attached to and located within the housing 100, in detail, to the lower case 120. In this case, the support member 123 may be coupled to the housing 100 by various methods such as a welding method, a bonding method using an adhesive, a hook coupling method, and the like (see FIG. 10).

One end of the vibrating member 200 may be fixed to the supporting member 121 and the vibrating member 200 may be vibrated in a state in which the one end thereof is fixed to the supporting member 121. In detail, the vibrating member 200 is basically provided in a cantilever scheme, to enables a free end portion thereof to vibrate.

In detail, by the supporting member 121 protruding from the lower case 120, an air gap G allowing for vibrations of the vibrating member therein may be provided between the vibrating member 200 and the lower case 120.

Meanwhile, in the housing 100, a stopper 130 capable of preventing collision with the vibrating member 200 and adjusting a displacement of the vibrating member 200 may be provided, and the stopper 130 may be in contact with the vibrating member 200 at the time of driving the vibrator 10.

In detail, in the case in which the vibrator 10 is driven, the vibrating member 200 may be vibrated, and in this case, the vibrating member 200 may collide with an inner side surface of the housing 100. Here, the vibrating member 200 may be damaged due to the collision between the vibrating member 200 and the housing 100.

Therefore, the stopper 130 may be provided in the housing 100, such that collisions between the vibrating member 200 and the housing 100 may be prevented and the displacement amount by which the vibrating member 200 is vibrated may be adjusted.

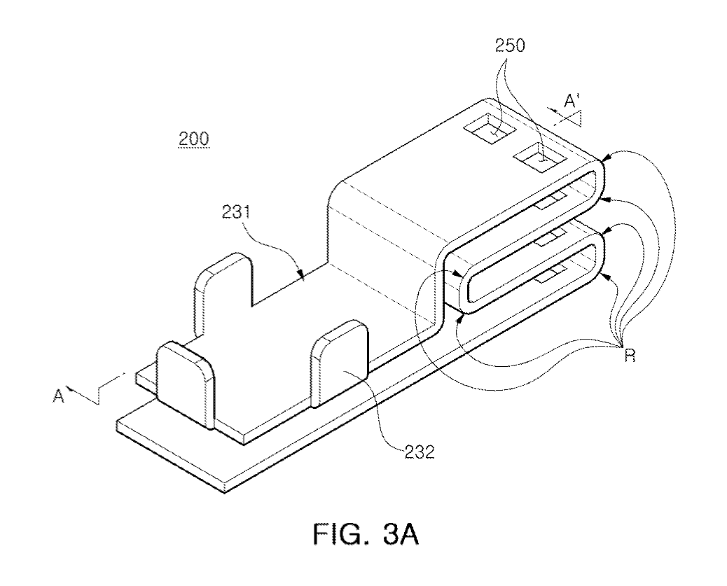

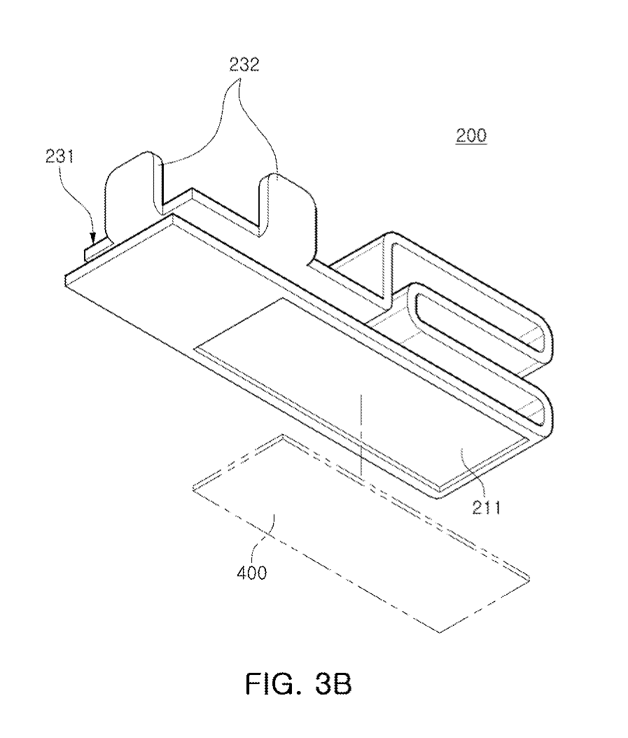

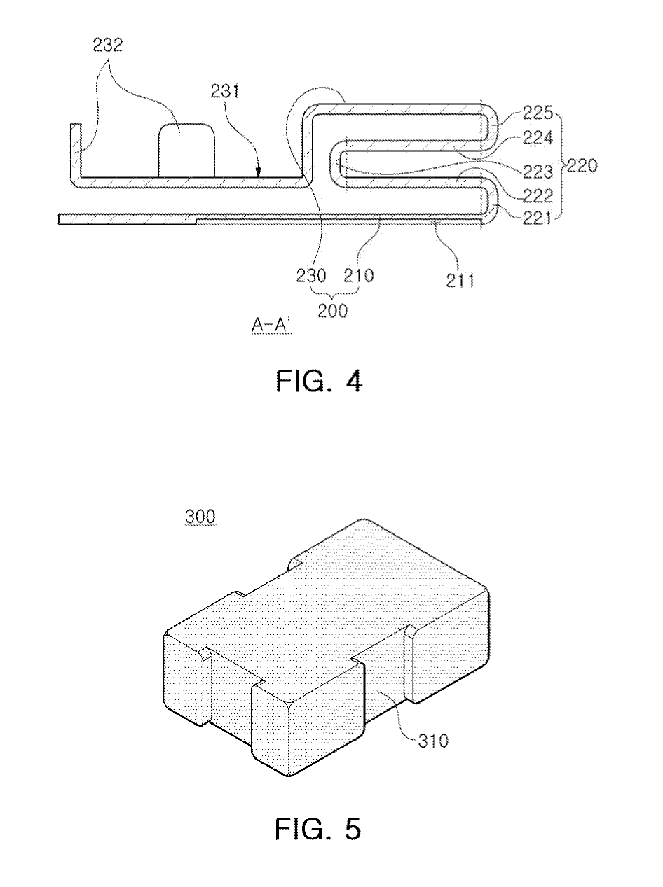

FIG. 3A is a perspective view of a vibrating member 200 according to an exemplary embodiment of the present disclosure, FIG. 3B is a bottom perspective view of the vibrating member 200 according to an exemplary embodiment of the present disclosure, and FIG. 4 is a cross-sectional view taken along line A-A′ of FIG. 3A.

Referring to FIGS. 3A to 4, the vibrating member 200 may be provided so that one end thereof may be fixed to an inner surface of the housing 100 and the other end thereof may be vibrated.

In detail, the vibrating member 200 may include a first member 210 having one end fixed to the housing and the other end which is a free end, a second member 220 extended from the other end of the first member 210, upwardly from the first member 210, and a third member 230 extended from the second member 220 in a direction of one end of the first member 210, and the first to third members 210, 220, and 230 may be respectively provided with at least one damper 240 for preventing collisions among the first, second and third members of the vibrating member 200.

Here, defining terms about a direction, an upper surface of a member refers to one surface of the member facing the upper case 110 and a lower surface of the member refers to one surface of the member facing the lower case 120.

The first member 210 may have one end fixed to the supporting member 121. In detail, the one end of the first member 210 may be a fixed end 216 fixed to the supporting member 121 and the other end thereof may be a free end 217. In this case, a method for fixing the first member 210 may be at least one of various methods such as a welding method, a bonding method using an adhesive, and the like.

In addition, the air gap G may be provided between the first member 210 and the lower case 120.

Meanwhile, the first member 210 may be provided with at least one piezoelectric element 400 exciting the vibrating member 200 by an electrical signal.

Here, the piezoelectric element 400 may be formed using a polymer material or a lead zirconate titanate (PZT) material. However, the material of the piezoelectric element 400 is not necessarily limited thereto, and the piezoelectric element formed of various materials capable of exciting the vibrating member 200 may be used.

In addition, one surface of the first member 210 may be provided with a coupling groove 211 in which the piezoelectric element 400 may be disposed to be coupled thereto, and the coupling groove 211 may be provided to correspond to an appearance of the piezoelectric element 400.

In detail, the piezoelectric element 400 is seated in the coupling groove 211 to be coupled thereto, and as a result, the piezoelectric element may be firmly coupled to the first member 210.

The second member 220 may be provided to be extended from the other end of the first member 210, upwardly from the first member 210 by enabling the other end of the first member 210 to be bent and subjected to a bending process performed a plurality of times, and in this case, a curvature R may be formed in a portion in which the first member 210 and the second member 220 are connected to each other.

Here, a principle in which the vibrator 10 according to an exemplary embodiment of the present disclosure allows for a reduced size thereof while maintaining a resonance frequency will be briefly described with reference to Equation 1 and Equation 2.

$$\begin{matrix}K ∝ \frac{1}{{L}^{3}} & 〈 Equation 1 〉 \\ ω = \sqrt{\frac{K}{m}} & 〈 Equation 2 〉\end{matrix}$$

In the above Equations, ‘K’ refers to a proportional constant, ‘L’ refers to a length of the vibrating member, ‘m’ refers to a weight of the vibrating member, and ‘ω’ refers to a resonance frequency.

Referring to Equations 1 and 2, the resonance frequency may be increased as the length of the vibrating member is decreased, and may be decreased as the length of the vibrating member is increased.

Therefore, in a case in which the length of the vibrating member is decreased in order to miniaturize the vibrator, the resonance frequency is increased, such that the vibrator may be difficult to function as a vibration generating apparatus.

In detail, since the vibrator 10 according to an exemplary embodiment of the present disclosure includes the vibrating member 200 having a bent form, an overall volume of the vibrator 10 may be decreased while maintaining an overall length of the vibrating member 200.

Meanwhile, the second member 220 is extended from the other end of the first member 210 and may be vertically bent therefrom and subjected to at least four bending processes. Hereinafter, a configuration in which the second member 220 is bent four times will be described by way of example.

The second member 220 includes a first bend portion 221 provided to be extended upwardly from the first member 210, a second bend portion 222 provided to be extended from the first bend portion 221 in a direction of one end of the first member 210, a third bend portion 223 provided to be extended from the second bend portion 222 upwardly from the second bend portion 222, a fourth bend portion 224 provided to be extended from the third bend portion 223 in a direction of the other end of the first member 210, and a fifth bend portion 225 provided to be extended from the fourth bend portion 224, upwardly from the fourth bend portion 224.

In this case, the curvature R may be formed in portions in which the first to fifth bend portions 221, 222, 223, 224, and 225 are connected, and the second bend portion 222 and the fourth bend portion 224 may be provided to be parallel to each other.

In addition, the second bend portion 222 may be provided to be parallel to the first member 210 opposing the second bend portion 222, and the fourth bend portion 224 may be provided to be parallel to the third member 230 opposing the fourth bend portion.

In addition, the first to fifth bend portions 221, 222, 223, 224, and 225 may be provided with a damper 240 for preventing collisions occurring at the time of driving the vibrator 10.

The third member 230 may be provided to be extended from the second member 220 in a direction of one end of the first member 210, and a curvature R may be formed in a portion in which the second member 220 and the third member 230 are connected.

In addition, the third member 230 may be extended from the second member 220 in a direction perpendicular to a direction of the end portion of the second member 220.

Further, the third member 230 may be provided with a mass body coupling part 231 which is provided to be bent and has the mass body 300 coupled thereto.

Meanwhile, the drawings illustrate the configuration in which the third member 230 is bent in a direction in which the lower case 120 is provided to allow the mass body 300 to be coupled to an upper surface of the third member 230. However, the configuration of the third member 230 is not limited thereto. The third member 230 may be bent in a direction in which the upper case 110 is provided to allow the mass body 300 to be coupled to a lower surface of the third member 230.

In addition, outer surfaces of the mass body coupling part 231 may be provided as coupling protrusions 232 which are bent to protrude therefrom and which support the mass body 300.

Outer surfaces of the mass body 300, facing the coupling protrusions 232, may be provided with insertion grooves 310 into which the coupling protrusions 232 may be inserted, to be described below. The coupling protrusions 232 may be inserted into the insertion grooves 310 to be coupled thereto.

In addition, the mass body coupling part 231 and the mass body 300 may be coupled to each other by at least one of a welding method or a bonding method using an adhesive, and may be coupled to each other via only mechanical coupling performed between the coupling protrusion 232 and the insertion groove 310.

In addition, at least a portion of the third member 230 may be positioned on an upper portion of the supporting member 121 so as to overlap each other.

Meanwhile, the vibrating member 200 may be provided with at least one elastic deformation assisting hole 250 for reducing strength thereof so as to facilitate elastic deformation.

In detail, the elastic deformation assisting hole 250 may allow the vibrating member 200 to be easily elastic-deformed at the time of driving the vibrator 10 by reducing the strength of the vibrating member 200.

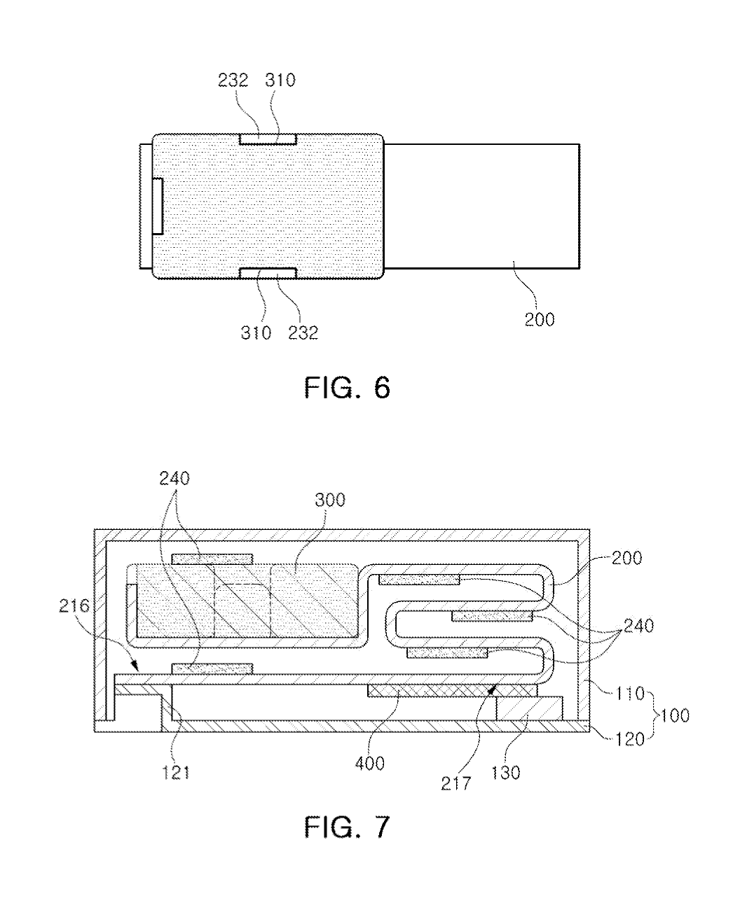

FIG. 5 is a perspective view of a mass body 300 according to an exemplary embodiment of the present disclosure and FIG. 6 is a plan view illustrating a form in which the mass body 300 and the vibrating member 200 according to an exemplary embodiment of the present disclosure are coupled.

Referring to FIGS. 5 and 6, the mass body 300 may be connected to the vibrating member 200 to be vibrated together therewith at the time of vibration of the vibrating member 200 to thereby serve to increase a vibration amount of the vibrating member 200. The vibrating member 200 may be located on one side of the vibrating member 200.

In this case, the mass body 300 may be located in various positions on the vibrating member 200. Here, a configuration in which the mass body 300 is located on the third member 230 of the vibrating member 200 will be described below by way of example.

The mass body 300 may be coupled to the mass body coupling part 231 of the third member 230 and may be coupled to the mass body coupling part 231 via at least one of a welding method and a bonding method using an adhesive.

In addition, the insertion grooves 310 may be provided in outer surfaces of the mass body 300 as described above.

Here, the coupling protrusions 232 provided with the third member 230 may be inserted into the insertion grooves 310.

As a result, the mass body 300 may be more stably coupled to the third member 230.

In addition, the mass body 300 may be provided with at least one damper 240 for preventing collisions with the housing 100.

Referring to FIG. 2, the piezoelectric element 400 may have warpage generated therein by an electrical signal to serve to excite the vibrating member 200, may be provided on one surface of the first member 210 facing the housing 100 or the other surface opposite thereto.

However, a position in which the piezoelectric element 400 is provided and the number of piezoelectric elements 400 may be variously changed. In detail, the piezoelectric element may be provided on at least one of the first member to the third member.

In this case, at least a portion of the mass body 300 may be positioned above the piezoelectric element 400 and a center of the piezoelectric element 400 may be positioned toward the other end of the first member 210 serving as a free end thereof.

In addition, the piezoelectric element 400 may be formed using a polymer material or a lead zirconate titanate (PZT) material. However, the material of the piezoelectric element 400 is not limited thereto, and the piezoelectric element formed of various materials capable of generating vibrations in the vibrating member 200 may be used.

Meanwhile, the first member 210 may be provided with a coupling groove 211 formed therein, in which the piezoelectric element 400 may be seated to be coupled thereto, and the coupling groove 211 may have a form corresponding to an appearance of the piezoelectric element 400.

In this case, the piezoelectric element 400 is seated in the coupling groove 211 to be coupled thereto and thus firmly coupled to the first member 210.

FIGS. 7 through 9 are cross-sectional views of a vibrator in a coupled state according to other exemplary embodiments of the present disclosure.

Referring to FIGS. 7 through 9, a vibrator 10 according to exemplary embodiments of the present disclosure may include a housing 100, a vibrating member 200, a mass body 300, and a piezoelectric element 400.

In detail, the vibrator 10 according to another exemplary embodiment of the present disclosure illustrated in FIGS. 7 through 9 has the same configuration as that of the vibrator according to the foregoing exemplary embodiment of the present disclosure with reference to FIGS. 1 through 6, except for a position in which the piezoelectric element 400 is provided, which is provided as a difference therebetween. Therefore, a detailed description of the same configuration will be omitted and be replaced by the above-mentioned description.

Referring to FIG. 7, in the vibrator 10 according to another exemplary embodiment of the present disclosure, a piezoelectric element 400 may be located so that an end thereof toward the fixed end 216 of the vibrating member 200 is positioned more toward the free end 217 of the vibrating member 200 than an end of the mass body 300 toward the free end 217 of the vibrating member 200.

In detail, the mass body 300 may not be positioned above the piezoelectric element 400.

In addition, although the drawings illustrate a configuration in which the piezoelectric element 400 is provided on the lower surface of the first member 210, the position in which the piezoelectric element 400 is provided is not limited thereto, and the piezoelectric element 400 may be provided on the upper surface of the first member 210 and a plurality of piezoelectric elements may also be provided on the upper and lower surfaces of the first member.

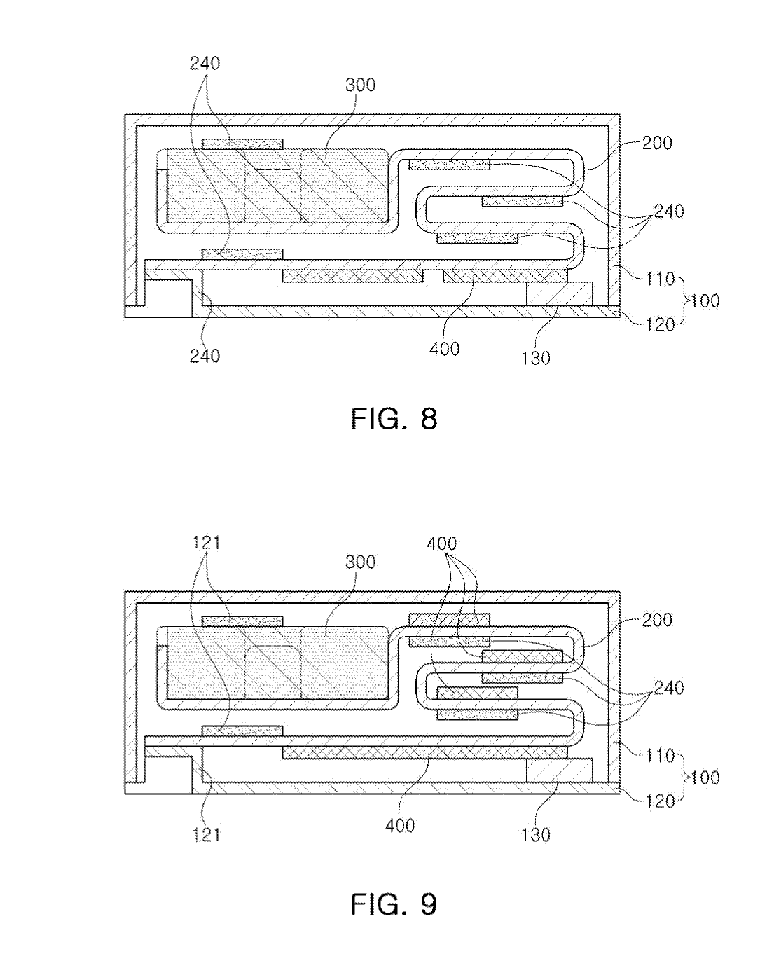

Referring to FIGS. 8 and 9, a plurality of piezoelectric elements 400 may be provided. In detail, according to a design, the plurality of piezoelectric elements 400 may be disposed to be adjacent to each other or spaced apart from each other.

In a case in which the piezoelectric elements 400 are spaced apart from each other, the plurality of piezoelectric elements 400 may be disposed on the first member 210 to be spaced apart from each other, and may also be disposed on at least one of the first to fifth bend portions 221, 222, 223, 224, and 225.

In other words, the position to which the piezoelectric element 400 is provided and the number of piezoelectric elements may be variously changed. The configurations described above are also included in the scope of the present disclosure.

According to exemplary embodiments of the present disclosure, a resonance frequency of a vibrator may be maintained and the size thereof may be decreased.

While exemplary embodiments have been shown and described above, it will be apparent to those skilled in the art that modifications and variations could be made without departing from the scope of the present invention as defined by the appended claims.

What is claimed is:

1. A vibrator, comprising:
a housing having an internal space;
a vibrating member having one end fixed to an inner surface of the housing and the other end provided to be vibratable;
a mass body provided in the vibrating member; and
at least one piezoelectric element disposed on one surface of the vibrating member,
wherein the vibrating member includes a first member having one end fixed to the housing and the other end which is a free end, a second member extended from the other end of the first member upwardly from the first member, and a third member extended from the second member in a direction of one end of the first member.

2. The vibrator of claim 1, wherein the second member is provided to be bent at least four times.

3. The vibrator of claim 1, wherein the second member comprises a first bend portion extended upwardly from the first member, a second bend portion extended from the first bend portion in a direction of one end of the first member, a third bend portion extended from the second bend portion upwardly from the second bend portion, a fourth bend portion extended from the third bend portion in a direction of the other end of the first member, and a fifth bend portion extended upwardly from the fourth bend portion.

4. The vibrator of claim 3, wherein the second bend portion and the fourth bend portion are provided to be parallel to each other.

5. The vibrator of claim 3, wherein the second bend portion is provided to be parallel to the first member opposing the second bend portion and the fourth bend portion is provided to be parallel to the third member opposing the fourth bend portion.

6. The vibrator of claim 1, wherein the second member is extended from the other end of the first member in a direction perpendicular to a direction of the other end of the first member, and the third member is extended perpendicularly from the second member.

7. The vibrator of claim 1, wherein the one end of the first member is fixed to the inner surface of the housing by at least one of a welding method and a bonding method using an adhesive.

8. The vibrator of claim 1, wherein one surface of the first member is provided with a coupling groove in which the piezoelectric element is seated to be coupled thereto.

9. The vibrator of claim 1, wherein the one end of the first member is coupled to a supporting member protruding into the internal space of the housing.

10. The vibrator of claim 9, wherein the first member and an inner surface of the housing have an air gap provided therebetween.

11. The vibrator of claim 9, wherein at least a portion of the third member is positioned above the supporting member to be overlapped therewith.

12. The vibrator of claim 3, wherein the first to fifth bend portions have curvatures formed in portions thereof in which the first to fifth bend portions are connected to one another.

13. The vibrator of claim 1, wherein the first member and the second member, and the second member and the third member have curvatures formed in portions in which the first member and the second member, and the second member and the third member are connected to each other, respectively.

14. The vibrator of claim 1, wherein the third member is provided with a mass body coupling part which is provided to be bent, and the mass body located thereon to be coupled to the third member.

15. The vibrator of claim 14, wherein an outer surface of the mass body coupling part is provided with a coupling protrusion which is bent to protrude and supports the mass body.

16. The vibrator of claim 15, wherein the outer surface of the mass body which faces the coupling protrusion is provided with an insertion groove into which the coupling protrusion is inserted.

17. The vibrator of claim 14, wherein the mass body and the mass body coupling part are coupled to each other by at least one of a welding method and a bonding method using an adhesive.

18. The vibrator of claim 1, wherein the piezoelectric element is provided on one surface of the first member facing the housing or on the other surface opposite to the one surface.

19. The vibrator of claim 1, wherein at least a portion of the mass body is positioned above the piezoelectric element to be overlapped therewith.

20. The vibrator of claim 1, wherein the piezoelectric element is provided so that a center of the piezoelectric element is positioned toward the free end of the first member.

21. The vibrator of claim 1, wherein the piezoelectric element is located so that an end of the piezoelectric element toward the fixed end of the vibrating member is positioned more toward the free end of the vibrating member than an end of the mass body toward the free end of the vibrating member.

22. The vibrator of claim 1, wherein the piezoelectric element is formed using a polymer material or a lead zirconate titanate (PZT) material.

23. The vibrator of claim 1, wherein the piezoelectric element is provided on at least one of the first member to the third member.

24. The vibrator of claim 1, wherein the piezoelectric element is provided as a plurality of piezoelectric elements provided on the first member.

25. The vibrator of claim 1, wherein the housing is provided with a stopper preventing collisions with the vibrating member and adjusting a displacement of the vibrating member.

26. The vibrator of claim 1, wherein the vibrating member is provided with a damper for preventing collisions between the vibrating members.

27. The vibrator of claim 1, wherein the mass body is provided with a damper for preventing collisions with the housing.

28. The vibrator of claim 1, wherein the vibrating member is provided with at least one elastic deformation assisting hole formed therein.

29. The vibrator of claim 3, wherein the piezoelectric element is provided on at least one of the first bend portion to the fifth bend portion.

30. A vibrator, comprising:
a housing forming an internal space;
a vibrating member having one end fixed to the housing and the other end provided to be vibratable;
at least one piezoelectric element disposed on one surface of the vibrating member; and
a mass body provided in the vibrating member,
wherein the vibrating member includes a first member having one end fixed to the housing and the other end which is a free end, a second member provided to be bent multiple times and extended from the other end of the first member upwardly from the first member, and a third member extended from the second member in a direction of one end of the first member.
